(19) United States
(12) Patent Application Publication
(10) Pub. No.: US 2007/0234398 A1
(43) Pub. Date: Oct. 4, 2007

(54) Controlling Access to Digital Media Content

(76) Inventor: Thomas Muehlbauer, San Diego, CA (US)

Correspondence Address: THOMAS MUEHLBAUER;UMC TECHNOLOGIES, INC., 650 COLUMBIA, #311, SAN DIEGO, CA, 92101, US

(21) Appl. No.: 11/681,707

(22) Filed: Mar. 2, 2007

Related U.S. Application Data
(60) Provisional application No. 60/778,964, filed on Mar. 2, 2006.

(51) Int. Cl. H04N 7/16

(52) U.S. Cl. 725/145

(57) ABSTRACT

An online system implemented as an interactive method that controls the distribution Internet media by providing a process that searches to locate media files (audio, video and graphical image, or other content) cataloged in a Universal Media Code (UMC) database pursuant to context-sensitive search criteria submitted by potential customers and upon locating one or more media files that match the search criteria, displays descriptive information to aid in the user's selection process, including but not limited to media artist and pricing information.

### CROSS-REFERENCE TO RELATED APPLICATIONS

This application claims priority to U.S. Provisional Ser. No. 60/778,964, filed Mar. 2, 2006, which is incorporated by reference in its entirety.

### TECHNICAL FIELD

This document relates to computerized information database and retrieval systems.

### BACKGROUND

With the increasing popularity of digital content (audio, video and graphic image files, hereafter referred to as “media files” or more simply as “content”) available on web servers connected to the Internet, it has become common for vendors to set up online “stores” or commercial websites for marketing and selling their products. These stores typically include electronic catalogs that can be browsed interactively by potential customers via the Internet, an online services network, or another type of system that supports interactive electronic browsing. However, the inventory found in these online stores occasionally is not owned by the vendor.

Media piracy is a significant problem on the Internet. When customers purchase counterfeit copies of Media the bona fide owners and artists are deprived of revenue. Regrettably it is almost impossible with current systems to police the tens of millions of media files on the Internet to assure the proper collection and payment of revenues.

### SUMMARY

In an implementation, a computer-implemented method of controlling access to digital media content includes cataloging digital media content items in a central database according to a unique access information provided for each digital media content item; and controlling access to distribution of the digital media content items based on one or more control parameters stored in the central database. The unique access information can be encoded in a universal media code record, each item of digital media content having a corresponding universal media code record. The unique access information may include one or more of an online access identity field, an online access password field, and a security identification field.

Any or all of these methods and techniques may be implemented in a system that includes a data repository including multiple records, each record corresponding to a unique item of digital media content; and one or more software processes executing on one or more computer systems, the one or more software processes configured to perform appropriate operations.

Details of one or more embodiments are set forth in the accompanying drawings and the description below. Other features and advantages will be apparent from the description and drawings, and from the claims.

### DESCRIPTION OF DRAWINGS

FIG. 1 illustrates a universal media code record.

FIG. 2 is a block diagram of an example media system using a universal media code.

FIG. 3 is a flow chart of an example method for identifying duplicate media content.

FIG. 4 is a flow chart of an example method for cataloguing and distributing information corresponding to media content.

FIG. 5 is a flow chart of an example method for controlling access to media content.

FIG. 6 is a flow chart of an example method for using fingerprint information to identify duplications of media content.

FIG. 7 is a flow chart of an example method for receiving media content.

FIG. 8 is a flow chart of an example method for delivering media content.

FIG. 9 is a block diagram of a computing system that can be used in connection with computer-implemented methods described in this document.

Like reference symbols in the various drawings indicate like elements.

### DETAILED DESCRIPTION

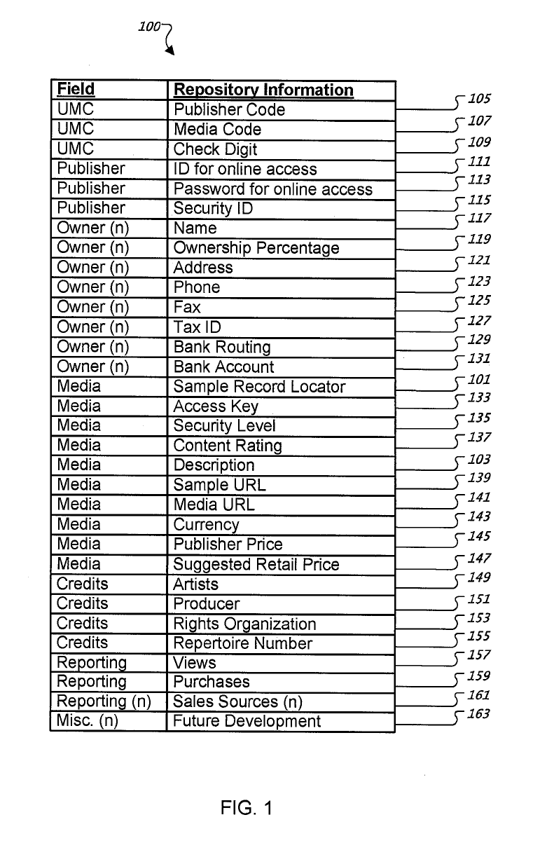

FIG. 1 illustrates a universal media code (UMC) record 100. A UMC record can be used to represent media content information. Media content information can specify the location and characteristics of media content, to name two examples. The media content information stored in the UMC record can be used to determine the uniqueness of new media content submitted to a server. For example, comparing fields of the UMC record 100 can determine if media content is unique. Media content can include videos, music, images, live TV, and the like. Additionally, the media content can be a media file (e.g., MP3, AVI, JPEG, etc.) or a media stream (e.g., a video stream or a music stream), or some combination thereof (e.g., a media file that when opened connects to a media stream).

A system that uses UMC records can, for example, be used to determine and maintain ownership information for received media content. The ownership information can include payment information to facilitate expedited payments when media content is purchased (e.g., through a web site, over a cell phone, or when using a television). In certain implementations, a UMC record is generated when one or more portions of one or more pieces of media content are sent to one or more servers for processing.

When media content is received, the servers can generate a digital fingerprint of the media content. In certain implementations, fingerprinting can be accomplished by using a hash table to generate a bit signature (i.e., fingerprint) of the media content which can be compared to other fingerprint information identified by the UMC record. For example, the locations of the fingerprints can be stored in the UMC records and accessed during fingerprint comparisons. In certain implementations, more than one fingerprint can be generated from a single instance of media content by, for example, using additional fingerprinting heuristics or third party fingerprint plug-ins. Moreover, the additional fingerprints can be selected at random intervals from the received media content. If, for example, the fingerprints do not match, then the received media content is determined to be unique and a new UMC record can be generated to represent the media content information. If, for example, the fingerprints do match, then the received media content may be a duplicate, and a process to reconcile media ownership can be initiated. The determination of unique and duplicate media content is described in more detail below.

The UMC record can be stored and referenced in a database using known database routines. Example databases include, but are not limited to, an Oracle database available from Oracle (Redwood Shores, Calif.), a MySQL database available from MySQL AB (Uppsala, Sweden and Cupertino, Calif.), a SQL Server database available form Microsoft (Redmond, Wash.), a Apache Web Server database available from The Apache Software Foundation (Forest Hill, Md.) and a JBoss Application Server database available from Red Hat (Atlanta, Ga.). In certain implementations, portions of the UMC record can be encoded to maintain established security protocols and procedures.

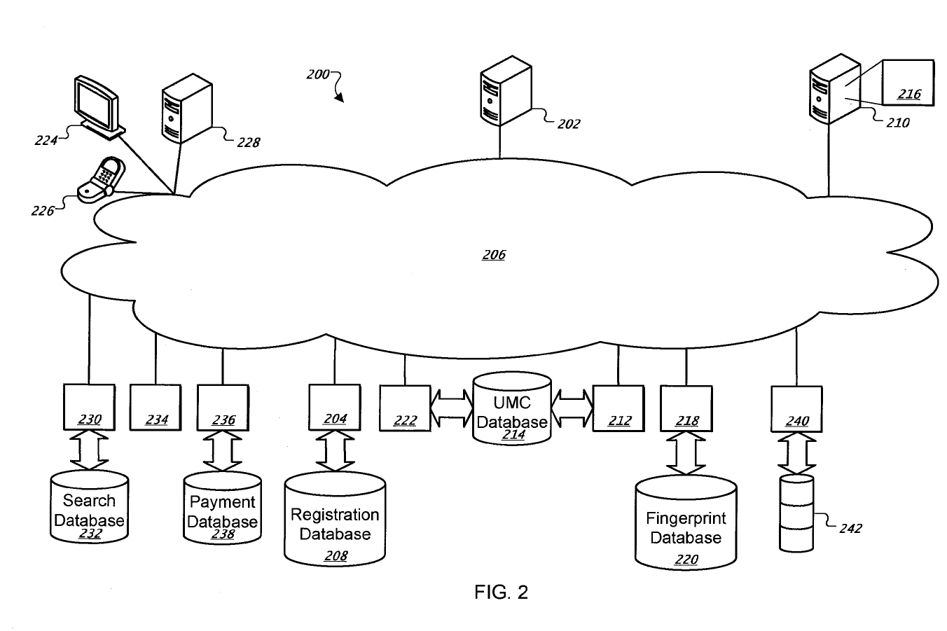

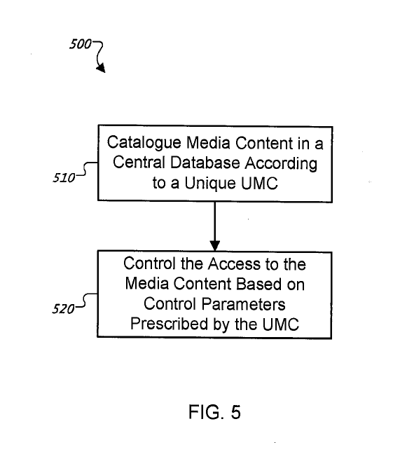

Referring now to FIG. 1, an example UMC record 100 can include individual fields. Field 105 specifies a publisher code and, in certain implementations, is represented by a 6-digit hexadecimal number. The publisher code can be generated when a media content owner registers themselves with a UMC server (described in more detail below in reference to FIG. 2). Field 107 specifies a media code and, in certain implementations, is represented by a 9-digit hexadecimal number. The media code can be incremented each time new media content is received from a publisher (i.e., a publisher code can be static while a media code can represent the total number of media content instances that the publisher has sent to the UMC servers). Field 109 specifies a check digit. The check digit is analogous to a check-sum and can be used to ensure the publisher and media codes of fields 105 and 107, respectively, are correct. Fields 105, 107, and 109 can be concatenated to form a single UMC. In certain implementations, the concatenation can yield a hexadecimal representation (e.g., 0x0caf59-387fed10a-f) or another representation. For example, LMC HER9G9-ILETGW4WRT-Y can be formed by concatenating fields 105, 107 and 109, respectively, and mapping the hexadecimal values to alpha-numeric characters. As described in reference to FIG. 5, the concatenation of fields 105, 107 and 109 can be considered unique. The UMC portions (i.e., field 105, 107, and 109) and combinations thereof can be used in database queries that can return other information represented in the UMC record.

Field 111 can specify an ID for online access, field 113 can specify a password associated with the ID used in on-line access, and field 115 can specify a security ID (e.g., a security clearance level). Fields 111, 113, and 115 can be used in various combinations to allow subscribers access to the media content while obfuscating the security measures and information from the subscribers. For example, in certain implementations, the media content resides on a secure server that requires a username and password to access the media content. Additionally, the media content is for sensitive eyes and has a classified security clearance. Once accessed, the UMC record can provide this information for the request, allowing the requestor access to the media content, which can prevent unnecessary distribution of the security information.

Fields 117, 119, 121, 123, 125, 127, 129, and 131 represent information specific to the one or more owners of the media content, as denoted by the “(n)” notation in “Owner (n).” This is because media content can have more than owner. For example, a song can be partially owner by the artist that recorded the song, and the publisher that published the song. Field 117 can specify the one or more names of the one or more owners. Field 119 can specify the ownership percentages for the one or more owners. In certain implementations, the value of field 119 can be a floating point value (e.g., a value from 0 to 1.0), or it can be an integer (e.g., a value from 0 to 100) that can specify the percentage. Field 121 can specify the addresses of the media content owners, field 123 can specify the phone numbers of the media content owners, and field 125 can specify fax numbers of the media content owners.

Field 127 can specify tax identification numbers for the media content owners. The tax identification numbers can be used when media content is purchased. For example, in certain implementations, the tax identification numbers can be used to automatically submit sales tax receipts to an appropriate governing body, such as the Internal Revenue Service (IRS). Field 129 can specify bank routing numbers. Field 131 can specify bank accounts numbers. In combination, fields 128 and 131 can allow automatic transfer of funds to media content owners. For example, after receiving payment, a media content owner can, automatically and periodically, be transferred a portion of the proceeds using the bank routing numbers and the bank account numbers for the owners of the media content. The remaining portion is transferred to media content vendors that include, but are not limited to, entities that enable purchase of the media content but may not own the media content. For example, Internet websites or software applications that allow purchase of media content, such as Amazon.com developed by Amazon.Com Inc. (Seattle, Wash.) or iTunes developed by Apple Inc. (Cupertino, Calif.).

Field 101 can specify the location of the fingerprints for the media content. As described previously, fingerprints can be digital representations of media content that can be used to determine uniqueness. Field 133 can specify an access key used to obtain the media content. For example, an access key can specify an encryption key to decrypt media content. In certain implementations, the media content can have imbedded security features, and the access key can additionally include credentials to allow access to the media content. For example, media content may require a license to allow access. The access key store in field 133 can include licensing information that when installed on a device (e.g., a handheld computer, cell phone, desktop computer, set-top box, etc.) allows the media content to be accessed. This can allow the distribution of protected media content and still ensure that only the purchaser of the media content can access the purchased content. Field 135 can specify the security level necessary to view the media content. In certain implementations, the security level is a number (e.g., “1,” “2,” “3,” etc.). In other implementations, the security level is a string (e.g., “normal,” “confidential,” “highly confidential,” etc.).

Field 137 can specify a content rating for the media content. The content rating can include ratings for organizations such as the Classification and Ratings Administration (e.g., G, PG, PG-13, R, NC-17), TV Parental Guidelines (e.g., TV-Y, TV-Y7, TV-Y7-FV, TV-C, TV-PG, TV-14, or TV-MA), Entertainment Software Rating Board (e.g., EC, E, E-10+, T, M, AD, RP), and the like. Field 103 can specify a description of the media content. Example descriptions include, but are not limited to, “Recording of Yankees vs. Twins 10/10/2006,” “My stand-up comedy routine,” and “LIVE—President's State of the Union Address.”

Field 139 can specify a location for a sample of the media content. In certain implementations, the sample can be provided by the media content owner, or a sample can be generated by automatically providing access to a short segment of the media content. For example, the automatically generated sample can provide access to the first 30 seconds of a song, or the first five minutes of a movie. Moreover, the sample can be used to entice a potential buyer to finalize a transaction. For example, a web page devoted to the media content can include reviews of the media content, a purchase price and a sample of the media content. Field 141 can specify a location of the media content that can be distributed to the buyer once a transaction has been concluded. Field 143 can specify a currency, for example, Euro, Dollar, Pound, and the like. Field 145 can specify a price paid to the one or more owners of the media content when the media content is purchased. Field 147 can specify a suggested retail price for media content vendors. When a user purchases media content, the vendor collects the purchase price through known electronic based transaction methods. As described previously, the price in field 145 can be automatically sent to the owners of the media through their respective bank and account numbers. It should be noted that Fields 145 and 147 can contain any amount, and as such, can facilitate free deliveries of media content, advertisement driven delivery of media content, currency driven delivery of media content, or some combination thereof. For example, if a user is willing to view an advertisement prior to delivery of media content, they may get a discounted price for the media content.

Any or all of fields 101, 133, 135, 137, 103, 137, 139, 141, 143, 145, and 147 can be used in combination to determine the uniqueness of received media content. For example, in certain implementations, the fingerprint specified by field 101, the description specified by field 103, the media content location specified by field 141 and/or 139 and a file format derived from the location fields can be used. For example, the media content URL “www.MyLocation.com\mymediacontent.mpg” of field 141 specifies MPEG encoded media content. In certain implementations, the received media content can be tested using known practices and procedures to determine if the encoding matches the file type. This can prevent senders of media content from intentionally or unintentionally misrepresenting ownership. For example, if an owner has already registered mymediacontent.mpg, someone else may not be able to register mymediacontent.mpg as mymediacontent.mov because the media content test can determine that mymediacontent.mov is actually MPEG encoded, and thus is registered media content mymediacontent.mpg.

Field 149 can specify the artists of the media content and field 151 can specify the producers of the media content. Field 153 can specify one or more rights organizations associated with the media content. Example organizations include, but are not limited to, Broadcast Music Incorporated (BMI) and the America Society of Composers, Authors, and Publishers (ASCAP). Typically, rights organizations maintain a catalog of copyrighted works which can be used to determine an owner for a specific piece of media content. Field 155 can specify one or more repertoire numbers which can be used to specify media content in a catalog belonging to a media rights organization. For example, ASCAP may contain a repertoire number for a pilot episode “My Pilot Episode” authored by Joe Author. If someone other than Joe Author attempts to register “My Pilot Episode,” the repertoire number can be used to help resolve ownership of the media content.

Field 157 can specify the number of times a unique instance of media content has been viewed. For example, in certain implementations, each time someone clicks on a link to “My stand-up comedy routine,” information, such as run time, user ratings, and a media content sample can be displayed. Additionally, viewing this information can increment the number of times that “My stand-up comedy routine” has been viewed. Field 159 can specify the number of times media content is purchased. For example, after viewing the sample, a user can purchase “My stand-up comedy routine” by clicking on another link. After the transaction is successful, the media content can be delivered to the user, and the number of purchases can be incremented. Field 161 can specify information related to different sales sources. For example, different media content vendors may have different values for media content viewed and media content purchased. These individual values can be contained in the sales source field 161. In other words, fields 157 and 159 can be aggregations of values included in field 161.

Field 163 can be used for future development. For example, field 163 can include promotional prices that are different than fields 145 or field 147. Moreover, field 163 can include a promotional period, a promotional bundle (e.g., purchase a movie and its accompanying soundtrack at a reduced price), or other information.

In certain implementations, the UMC record can be stored in a database on a central server. Because the one or more UMC records can be accessed and processed on a central server, it can reduce the amount of overhead shouldered by a media content vendor. For example, the media content vendor can use the pricing and banking information included in a UMC record to avoid implementing or licensing a payment system. Moreover, because the UMC record database can be continually updated by owners of media content and can include the location of media content, media content vendors can avoid the overhead of maintaining and storing the media content on their respective servers. Moreover, one or more fields in the UMC record 100 can be optional fields. For example, if the tax ID field 127 is not specified, a UMC request can be processed, but the automatic tax payments may not be available.

FIG. 2 is a block diagram of an example media system architecture 200 using a universal media code. As described previously, a UMC record can be stored on a central server in a database for retrieval. The stored UMC record can be used to determine uniqueness of received media content, or can be used to specify payment parameters, to name two examples. In certain implementations, an owner of media content can register with a UMC registration module. For example, an owner can use a computer 202 to register with a registration module 204 over network 206. The network can be a LAN (e.g., an intranet) or a WAN (e.g., the Internet), or combinations thereof. In certain implementations, the communication over network 206 can be encrypted to provide additional data integrity and security The registration module 204 can communicate with a registration database 208 that can store information generated when the media content owner registers with the registration module 204. For example, the registration database 208 can include contact information (e.g., one or more phone numbers, one or more mailing addresses, one or more fax numbers, one or more email addresses, etc.), login credentials (e.g., a user name or a password), type of artist (e.g., author, composer, singer, actor, etc.), and the like. A registrant can enter information into the UMC registration module 204 using a user interface. For example, the registrant can use a traditional web-based interface (e.g., a web page) to enter in specific information. In certain implementations, the registration module 204 can generate a publisher code field 105 by incrementing a publisher count. For example, a first registrant can have publisher code 0x000001, a second registrant can have publisher code 0x000002, etc.

Once registered, media content owners can submit their media content to the UMC server. For example, a media content owner can use a computer 210 to submit media content to a media content submission module 212 over network 206. In certain implementations, computer 210 can also be computer 202. The media content submission module 212 can generate a UMC record (e.g., a UMC record 100 described in reference to FIG. 1) using information gathered during the submission process. The media content submission module 212 can store the generated UMC record into a UMC database 214 located on the UMC server. In certain implementations, submitting the media content can increment the media code field 107. For example, publisher denoted by value 0x000001 in the publisher code field 105 can submit three different instances of unique content where the media code field 107 for different UMC records 100 can contain the values 0x000000001, 0x000000002, and 0x000000003, respectively.

Submitting media content can be done manually. For example, media content information can be entered into a user interface and the described media content can be uploaded with the entered information. In certain implementations, manually entry of media content is done individually for each media content item. Additionally, submission of media content can be done automatically. In certain implementations, a media content owner can be optionally provided with a software application 216 that can use one or more configuration files to automatically generate the media content information that can be used to generate a UMC record. Moreover, the software application 216 can automatically upload one or more unique instances of media content to the UMC server. For example, a configuration file can specify that media content of type MP3 has a suggested retail price of 99 cents and the owner is paid 69 cents when the media content is purchased. The configuration files can be modified by the media content owner and loaded in the software application 216 to process automatic submissions or to facilitate different automated workflows. Additionally, during either manual or automatic submission, the media content's metadata can be used to extract other information. For example, in certain implementations, the author and title of a song can be extracted from the media content's metadata and automatically added to the media content information which can be used to generate a UMC record.

The submitted media content can be sent to an identity processing module 218 using network 206 to determine the uniqueness of the submitted media content. As described previously, one or more fingerprints of the media content can be generated. The newly generated fingerprints can be compared with other fingerprints stored in a finger print database 220 and other information to determine uniqueness. In certain implementations, to determine uniqueness, one or more fingerprints, a media content description, a media content's location, and a media content's file type can be compared with other entries in the UMC database 214 and the fingerprint database 220.

If, for example, the fingerprints match, but the location is different, the submitted media content may be a duplicate. In certain implementations, portions of fingerprints can be used to determine if media content is duplicated. For example, a media content owner can submit a montage of scenes. If any or all of the scenes in the montage have a matching fingerprint with other fingerprints in the fingerprint database 220, it may be a duplicate portion of media content.

Because it is not uncommon for the a second or third submitter of media content to be considered the rightful owner, in certain implementations, human intervention can be used to solve ownership conflicts. For example, the identity processing module 218 can identify submission that may require human intervention. In certain implementations, identified media content may be excluded from the UMC database 214 until ownership has been established. Once ownership has been established or the media content is found to be unique (e.g., human intervention determines, after review, that the submitted media content is unique), the identity processing module 218 can store the UMC record associated with the media content into the UMC database 214 through a UMC access module 222.

The UMC access module 222 can provide access to the UMC database 214. The UMC access module 222 can receive requests over the network 206 to distribute information located in the UMC database 214. For example, a user can use a television 224, a cell phone 226, or a computer 228 to access a media content search module 230 using network 206. In certain implementations, the television 224 can be connected to a set-top box. Additionally, the cell phone 226 can include a Binary Runtime Environment for Wireless (BREW; developed by Qualcomm (San Diego, Calif.)) interface and the computer 228 can include a user interface that can emulate a set-top box. For example, the user interface on computer 228 can include a virtual remote control and a screen to view the media content.

The search module 230 can accept one or more search criteria to search the UMC database 214. The search module 230 can search a search database 232 to retrieve UMC codes and other information related to the requested search. For example, a search with criteria including “Baseball” and “Twins” may return a list of media content including “Recording of Yankees vs. Twins 10/10/2006,” which may correspond to UMC “HER9G9-1LETGW4WRT-Y.” In certain implementations, the UMC code can be hidden from the user. The search module can send the results to the television 224, the cell phone 226, or the computer 228 over network 206. The results can be displayed by the devices 224, 226, and 228 using traditional display processes and procedures. In certain implementations, the search module 230 is a search module that is capable of delivering internet video and audio (i.e., a DIVA search module).

By selecting an item in the returned search results, the television 224, the cell phone 226, and the computer 228 can send a request to the search module 230. The search module 230 can access a UMC associated with the selected search result. The UMC can be sent to a UMC control module 234 over network 206. The UMC control module 234 can coordinate activities between UMC access module 222 and a billing and distribution module 236, to name two examples. In certain implementations, the UMC control module 234 can receive a UMC from the search module 230. The UMC control module 234 can communicate with UMC access module 222 over network 206 to access a UMC record stored in UMC database 214 corresponding to the UMC provided by the search module 230. The UMC control module 234 can return relevant information to the television 224, cell phone 226, and computer 228 over network 206. For example, the UMC control module 234 can send the purchase price to devices 224, 226, and 228. If the user agrees to purchase the media content, the UMC control module 234 can accept payment information and process the purchase order by communicating with billing and distribution module 236.

The billing and distribution module 236 can use the information contained within a UMC record to access, for example, a bank routing number and a bank account number. The billing and distribution module 236 can accept payment information from the UMC control module 234 a user device, or a media content vendor, to name three examples. The billing and distribution module 236 can use the information in the UMC record to process the payment. Moreover, the billing and distribution module 236 can store information relating to a purchase order in a payments database 238. For example, the payments database 238 can store the amount of payment, the time received, and the like. Additionally, in certain implementations, the payments database 238 can include user information. For example, a user can register with the billing and payments module 236 to setup a monthly subscription. In certain implementations, the subscription service can have multiple tiers. For example, a $4.99 monthly subscription can allow a user access to an unlimited number of songs, or a $19.99 monthly subscription can allow unlimited access to all available media content.

In certain implementations, the billing and distribution module 236 can automatically send a portion of the purchase to the owner of the media, or submit applicable taxes as provided by the information in the UMC record. For example, the billing and distribution module 236 can submit taxes to the IRS using the purchase price, calculate the taxes due, and automatically submit them to the IRS using the tax ID contained in field 127 of a UMC record. The billing and distribution module 236 can store the owner's transaction in the payments database 238. Additionally, the billing and distribution module 236 can send the UMC control module 234 a message when a purchase order has been successfully processed.

Referring again to UMC control module 234, the UMC control module 234 can grant access to the media access module 212 once the billing and distribution module 236 processes a successful payment. In certain implementations, the UMC control module 234 can communicate with media access module 212 on behalf of the user, or after the UMC control module 234 has granted access, the user can communicate directly with the media access module 212 through network 206. For example, UMC control module 234 can send a message to media access module 212 which can cause the media access module 212 to generate a temporary link to the media content and send the link to the user over network 206.

Referring again to media access module 212, as described previously, the media access module 212 can include routines to generate temporary access to a media content location stored in a UMC record in the UMC database 214. In certain implementations, for example, a common gateway interface (CGI) application can be used to generate a temporary universal resource locator (URL) to the media content specified by the UMC access module 234. By selecting the temporary URL, the user can access the media content on the owner's media content servers 240 without distributing a static link to the media content. Because the link is not static, the number of viewings of purchased media content can be controlled by terminating the temporary link after, for example, a pre-determined amount of time. The servers can distribute media content 242 to the user by way of download, display, stream, or other known forms of distribution.

In certain implementations, modules 204, 212, 218, 222, 230, 234 and 236 can be included on one or more servers. For example, architecture 200 can include a registration sever, a media access server, an identity processing server, a UMC access server, a search server, a UMC control server, and a billing and distribution server, where the servers include their respective modules. Moreover, in certain implementations, architecture 200 can include one or more of each of the modules or each of the servers to assuage bandwidth bottlenecks. For example, architecture 200 can include a registration server and multiple media access servers.

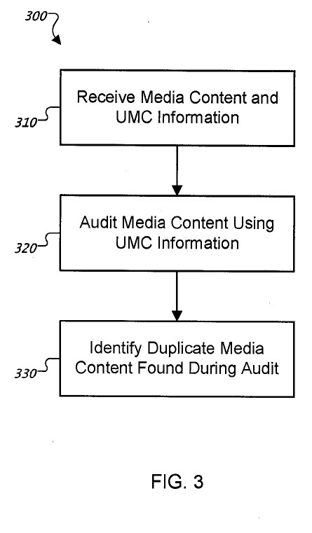

FIG. 3 is a flow chart of an example method 300 for identifying duplicate media content. In step 310, media content and UMC information is received. For example, referring to FIG. 2, media access module 212 can receive media content and UMC information from a media content owner's computer 210. In certain implementations, the media content and UMC information received can be supplied manually or automatically by application 216.

In step 320, the media content can be audited using UMC information. For example, referring to FIG. 2, UMC records in the UMC database 214 can be sent to identity processing module 218. Moreover, fingerprints can be generated and compared by the identity processing module 218. As described previously, generated fingerprints can be stored and compared with other fingerprints in fingerprint database 220.

In step 330, duplicate media content found during step 320 can be identified. For example, referring to FIG. 2, identity processing module 218 can alert a human operator that received media content may be a duplicate and intervention may be needed to determine a course of action. The operator can reject the content as a duplicate, remove a previously submitted instance of media content (e.g., because the previously submitted media content has an incorrect owner associated with the media content), or allow the media content as unique, to name three examples.

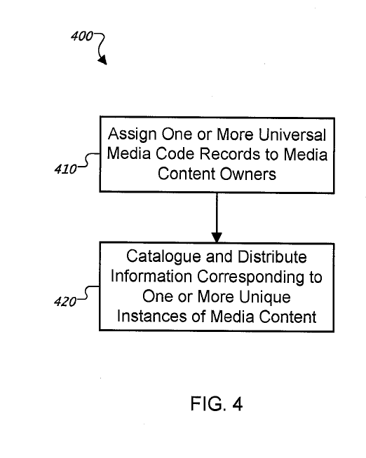

FIG. 4 is a flow chart of an example method 400 for cataloguing and distributing information corresponding to media content. In step 410, one or more UMC records can be assigned to media content owners. For example, referring to FIG. 2, after media content has been determined to be unique by identity processing module 218, the media access module 212 can generate one or more UMC records in the UMC database 214 based on the amount of media content received and the information supplied by the media content owner.

In step 420, information corresponding to one or more unique instances of media content can be catalogued and distributed to servers on a network. For example, referring to FIG. 2, information corresponding to one or more unique instances of media content can be distributed to a search module 230 using network 206. The search module 230 can store the information into a search database 232. In certain implementations, the search module may exist on an independently owned and operated search server. For example, search servers maintained by Google (Mountain View, Calif.). Moreover, the corresponding information can be sent to multiple search organizations. For example, in addition to the Google servers, information corresponding to one or more unique instances of media content can be sent to servers maintained by Yahoo! (Sunnyvale, Calif.), Microsoft (Redmond, Wash.), and the like.

FIG. 5 is a flow chart of an example method 500 for controlling access to media content. In step 510 media content can be catalogued in a central database according to a unique UMC. For example, referring to FIGS. 1 and 2, after the identity processing module 218 has determined received media content is unique, the media access module 212 can generate a unique UMC by concatenating the publisher field 105, the media code field 107 and the check digit field 109. Because each publisher code can be considered unique (e.g., because the publisher code is incremented each time a new publisher registers with the registration module 204) and the media code can also be considered unique (e.g., because the media code is incremented each time the publisher submits new media content), the concatenated UMC can be considered unique.

In step 520, access to the media content can be controlled based on control parameters prescribed in the UMC. For example, referring to FIGS. 1 and 2, if the UMC control module 234 determines that information in the request does not match one or more security credential fields (e.g., fields 111, 113, or 115), UMC control module 234 can deny the requestor access to the media access module 212.

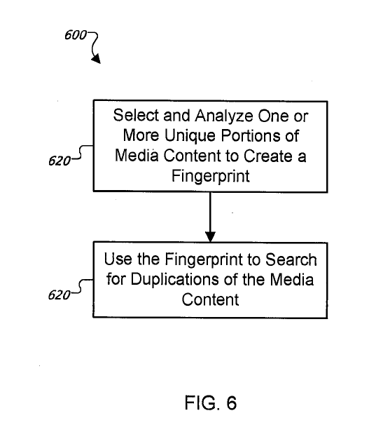

FIG. 6 is a flow chart of an example method 600 for using fingerprint information to identify duplications of media content. In step 620, a fingerprint can be created by selecting and analyzing one or more unique portions of received media content. For example, referring to FIGS. 1 and 2, the identity processing module 218 can generate a fingerprint using a hash function. The generated fingerprint can be stored in fingerprint database 220 and the location stored in the sample record locator field 101 of a UMC record. The UMC record can also be stored in the UMC database 214.

In step 620, the fingerprint information generated in step 610 can be used to search for duplications of the media content. For example, referring to FIG. 2, identity processing module 218 can use the generated fingerprint information and compare it to the other fingerprints in the database. In certain implementations, information from the UMC record can be used to constrain or refine the search. For example, if the UMC record specifies the received media content to be an image, song fingerprints can be omitted in the fingerprint search.

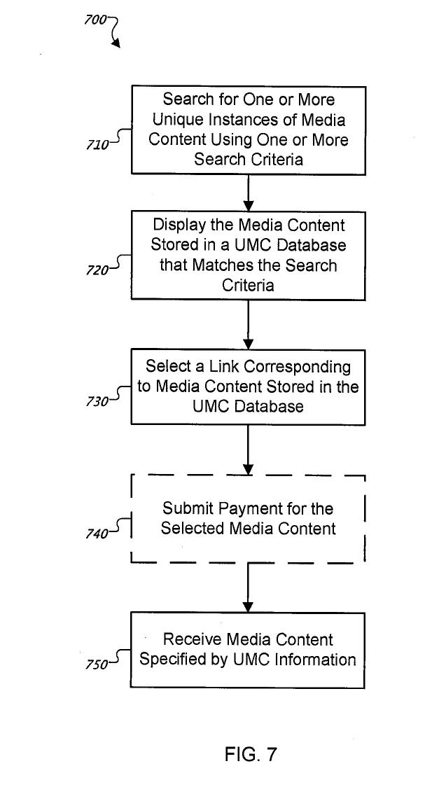

FIG. 7 is a flow chart of an example method 700 for receiving media content. In step 710, a user can use a device (e.g., a computer, a cell phone, or a television) to search for one or more unique instances of media content using one or more search criteria. For example, the user can enter the search “Television AND baseball AND Minnesota AND Twins.” The search criteria can be sent to one or more search services for processing. For example, referring to FIG. 2, the search criteria can be sent to a search module 230.

In step 720, the device can display the media content entries stored in a UMC database that matches the search criteria. For example, the device can display all of the media content entries corresponding to the recorded and live Minnesota Twins games submitted to the UMC database.

In step 730, the user can select a link from a list displayed in step 720 corresponding to media content stored in the UMC database. For example, the user can select the media content titled “Recording of Yankees vs. Twins 10/10/2006.” In certain implementations, selecting the link can bring the user to a webpage detailing additional information regarding the selected media content. For example, the webpage can display a purchase price, runtime, and user feedback of the selected media content. In certain implementations, the webpage can also include a sample of the media content.

In step 740, the user can optionally submit payment for the selected media content. For example, in certain implementations, the media content may be available for free or viewing an advertisement can allow delivery of the media content avoiding the need for the user to purchase the media content.

In step 750, the device can receive the media content selected in step 730 and optionally purchased in step 740 as specified by the UMC information. For example, referring to FIG. 1, the UMC information can include a media URL field 141 that can designate a location for the media content. In certain implementations, the media URL field 141 can specify a location that can generate a temporary link to the media content. For example, the media URL field 141 can specify the location of a CGI application that can generate a temporary URL to the media content.

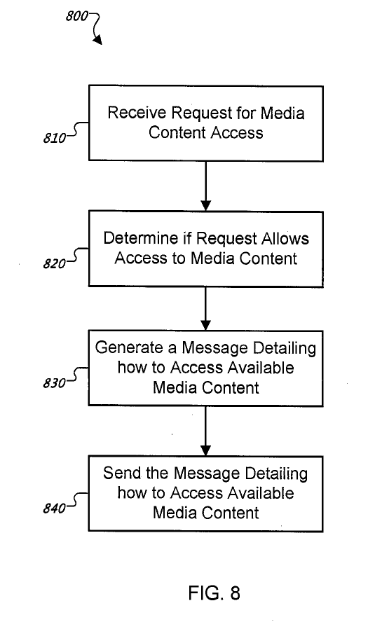

FIG. 8 is a flow chart of an example method 800 for delivering media content. In step 810 a request for media content access can be received. For example, referring to FIG. 2, UMC control module 234 can receive a request to access media content using network 206.

In step 820, the request can be analyzed to determine if it allows access to the media content. For example, referring to FIG. 2, UMC control module 234 can analyze the request to determine if it contains the correct username, password, or security clearance. The request can be compared to records included in the UMC database 214 to determine if the information in the media content access request matches the information in a UMC record.

In step 830, a message detailing how to access available media content can be generated. For example, referring to FIG. 2, UMC control module 234 can communicate with media access control module 212 if access is granted. Media access control module can generate a message that describes how to access the available media content. For example, the media access control module 212 can generate a URL which can point to the location of the media content. In certain implementations, the message may not access the media content directly but described how the media content is accessed. For example, the message can be a webpage that includes instructions, that when followed, grant access to the media content. Moreover, the message can be an email, an update to a webpage, a redirect to the media content, to name three examples.

In step 840, the message generated in step 830 can be sent detailing how to access the available media content. For example, referring to FIG. 2, media control module 234 can send an email using an SMTP protocol or update a webpage using an HTTP request using network 206.

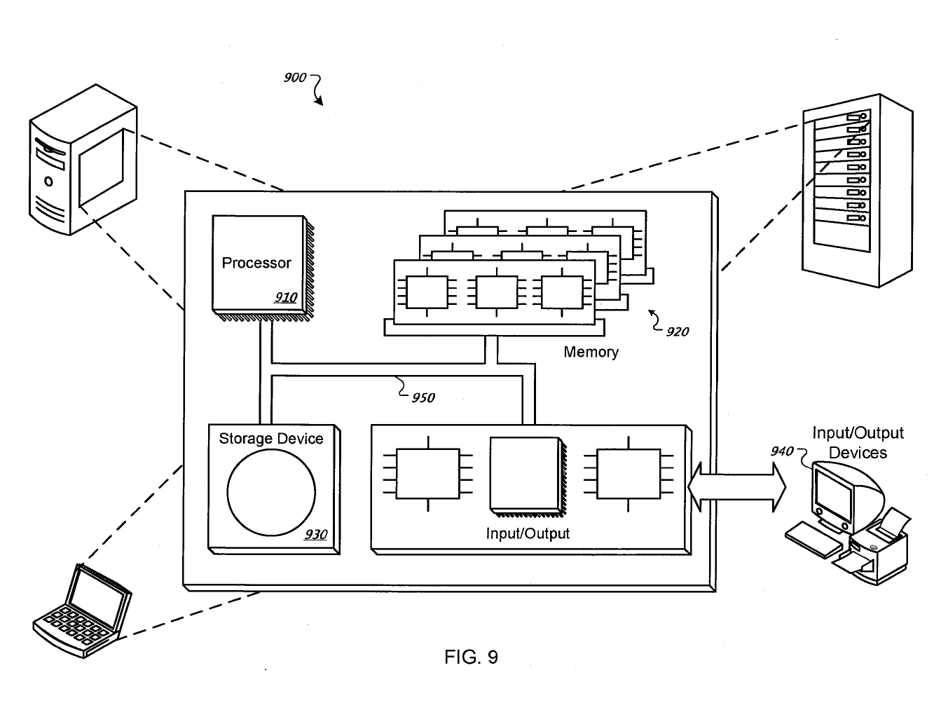

FIG. 9 is a schematic diagram of a generic computer system 900. The system 900 can be used for the operations described in association with any of the computer-implement methods described previously, according to one implementation. The system 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 may be a floppy disk device, a hard disk device, an optical disk device, or a tape device.

The input/output device 940 provides input/output operations for the system 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks.

The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of the claims. Accordingly, other embodiments are within the scope of the following claims.

What is claimed is:

1. A computer-implemented method of controlling access to digital media content, the method comprising:
cataloging digital media content items in a central database according to a unique access information provided for each digital media content item; and
controlling access to distribution of the digital media content items based on one or more control parameters stored in the central database.

2. The method of claim 1 wherein the unique access information is encoded in a universal media code record, each item of digital media content having a corresponding universal media code record.

3. The method of claim 2 wherein the unique access information comprises one or more of an online access identity field, an online access password field, and a security identification field.

4. A system for controlling access to digital media content, the system comprising:
a data repository comprising a plurality of records, each record corresponding to a unique item of digital media content;
one or more software processes executing on one or more computer systems, the one or more software processes configured to perform operations comprising:
catalog digital media content items in a central database according to a unique access information provided for each digital media content item; and
controlling access to distribution of the digital media content items based on one or more control parameters stored in the central database.

5. The system of claim 4 wherein the unique access information is encoded in a universal media code record, each item of digital media content having a corresponding universal media code record.

6. The system of claim 4 wherein the unique access information comprises one or more of an online access identity field, an online access password field, and a security identification field.
